(19) United States
(12) Patent Application Publication
(10) Pub. No.: US 2026/0003326 A1
(43) Pub. Date: Jan. 1, 2026

(54) SYSTEM AND METHOD FOR AUTO-CATEGORIZING ASSET CRITICALITY USING MACHINE LEARNING TECHNIQUE IN INDUSTRIAL CONTROL NETWORK

(71) Applicant: Honeywell International Inc., Charlotte, NC (US)

(72) Inventors: Harshal Haridas, PIPERSVILLE, PA (US); Alex Zelichenko, Kochav Yair (IL)

(21) Appl. No.: 18/754,173

(22) Filed: Jun. 26, 2024

(51) Int. Cl. G05B 13/02

(52) U.S. Cl. CPC G05B 13/0265

(57) ABSTRACT

A method for auto-categorizing asset criticality using a machine learning (ML) technique in an industrial control network is disclosed. The method comprises selecting, via at least one processor, a plurality of asset factors associated with one or more assets of the industrial control network; assigning, via the at least one processor, a scale factor to each asset factor; creating, via the at least one processor, one or more clusters of the plurality of asset factors based at least on the scale factor; determining, via the at least one processor, centroids from each of the one or more clusters based at least on a Euclidean distance, to train a ML model; and deploying, via the at least one processor, the trained ML model comprising the one or more clusters having respective centroids determined, within the industrial control network to categorize an asset criticality for each of the one or more assets.

### TECHNOLOGICAL FIELD

The present invention relates to an industrial control network, and more particularly relates to a system and method for auto-categorizing asset criticality using artificial intelligence (AI)/machine learning (ML) technique in the industrial control network.

### BACKGROUND

Industrial Control Systems (ICS) play a critical role in managing and controlling various industrial processes, including manufacturing, energy production, and transportation. The ICS rely heavily on interconnected devices and software to monitor and regulate physical processes, making the ICS susceptible to cyber threats and vulnerabilities. Cybersecurity in ICS environments has been a significant concern, with numerous incidents highlighting potential risks associated with cyber-attacks on infrastructure. Cyber threats targeting Industrial Control Systems (ICS) can cause significant harm, both in terms of physical damage and operational disruptions. The consequences of a successful cyber-attack on ICS can be severe, given the critical nature of the industries that rely on these systems, such as energy, water supply, manufacturing, and transportation. Malware or unauthorized commands can cause industrial equipment to operate outside of safe parameters, leading to overheating, overloading, or mechanical failure. Attackers can alter data within the ICS, leading to incorrect decision-making based on false information. This can compromise product quality, safety, and efficiency. Sensitive information, such as operational data, proprietary technology, and personal data, can be stolen, leading to competitive disadvantages and regulatory penalties.

The inventors have identified numerous areas of improvement in the existing technologies and processes, which are the subjects of embodiments described herein. Through applied effort, ingenuity, and innovation, many of these deficiencies, challenges, and problems have been solved by developing solutions that are included in embodiments of the present disclosure, some examples of which are described in detail herein.

### BRIEF SUMMARY

The following presents a simplified summary in order to provide a basic understanding of some aspects of the present disclosure. This summary is not an extensive overview and is intended to neither identify key or critical elements nor delineate the scope of such elements. Its purpose is to present some concepts of the described features in a simplified form as a prelude to the more detailed description that is presented later.

In one example embodiment, a method for auto-categorizing asset criticality using a machine learning (ML) technique in an industrial control network is disclosed. The method comprises selecting, via at least one processor, a plurality of asset factors associated with one or more assets of the industrial control network. The plurality of asset factors corresponds to a specific criteria used to access characteristics, vulnerabilities, and criticality of each of the one or more assets within the industrial control network. Further, the method comprises assigning, via the at least one processor, a scale factor to each asset factor of the plurality of asset factors. Further, the scale factor defines a weightage assigned to each asset factor of the plurality of asset factors. Further, the method comprises creating, via the at least one processor, one or more clusters of the plurality of asset factors based at least on the scale factor assigned. Further, the method comprises determining, via the at least one processor, centroids from each of the one or more clusters based at least on a Euclidean distance, to train a machine learning (ML) model. The centroids are configured to uniquely define each of the one or more clusters, and the Euclidean distance corresponds to a total numerical difference of coordinates of the plurality of asset factors. Thereafter, the method comprises, deploying, via the at least one processor, the trained ML model comprising the one or more clusters having respective centroids determined, within the industrial control network to categorize an asset criticality for each of the one or more assets.

In some embodiments, the plurality of asset factors comprises at least one of an active own operational technological (OT) ports, a direct connection to known OT endpoint, an indirect connection to the OT endpoints, use of OT protocols, a number of connections to information technology (IT) endpoints, or a connection to external subnets.

In some embodiments, the one or more assets within the industrial control network comprises at least one of programmable logic controllers (PLCs), remote terminal units (RTUs), supervisory control and data acquisition systems (SCADA), distributed control systems (DCS), one or more sensors, or actuators.

In some embodiments, the asset criticality categorized for each of the one or more assets corresponds to at least one of high criticality, medium criticality, or low criticality. In some embodiments, the method further comprising determining, via the at least one processor, the asset criticality based at least on a criticality score associated with each of the one or more assets.

In some embodiments, the scale factor for each asset factor is configured to allow a spatial distance between the one or more clusters and eliminate errors induced by intersections of the one or more clusters. In some embodiments, the scale factor is either assigned manually by a user or assigned automatically using artificial intelligence (AI)/(ML) technique.

In another example embodiment, a system for auto-categorizing asset criticality using a machine learning (ML) technique in an industrial control network is disclosed. The system comprises a memory and at least one processor communicatively coupled to the memory. The at least one processor is configured to select a plurality of asset factors associated with one or more assets of the industrial control network. The plurality of asset factors corresponds to a specific criteria used to access characteristics, vulnerabilities, and criticality of each of the one or more assets within the industrial control network. Further, the at least one processor is configured to assign a scale factor to each asset factor of the plurality of asset factors. Further, the scale factor defines a weightage assigned to each asset factor of the plurality of asset factors. Further, the at least one processor is configured to create one or more clusters of the plurality of asset factors based at least on the scale factor assigned. Further, the at least one processor is configured to determine centroids from each of the one or more clusters based at least on a Euclidean distance, to train a machine learning (ML) model. The centroids are configured to uniquely define each of the one or more clusters, and the Euclidean distance corresponds to a total numerical difference of coordinates of the plurality of asset factors. Thereafter, the at least one processor is configured to deploy the trained ML model comprising the one or more clusters having respective centroids determined, within the industrial control network to categorize an asset criticality for each of the one or more assets.

In another example embodiment, a non-transitory machine-readable information storage medium for auto-categorizing asset criticality using a machine learning (ML) technique in an industrial control network is disclosed. The non-transitory machine-readable information storage medium comprising one or more instructions which when executed by at least one processor cause the at least one processor to select a plurality of asset factors associated with one or more assets of an industrial control network, wherein the plurality of asset factors correspond to a specific criteria used to access characteristics, vulnerabilities, and criticality of each of the one or more assets within the industrial control network; assign a scale factor to each asset factor of the plurality of asset factors, wherein the scale factor defines a weightage assigned to each asset factor of the plurality of asset factors; create one or more clusters of the plurality of asset factors based at least on the scale factor assigned; determine centroids from each of the one or more clusters based at least on a Euclidean distance, to train a machine learning (ML) model, wherein the centroids are configured to uniquely define each of the one or more clusters, and wherein the Euclidean distance corresponds to a total numerical difference of coordinates of the plurality of asset factors; and deploy the trained ML model comprising the one or more clusters having respective centroids determined, within the industrial control network to categorize an asset criticality for each of the one or more assets.

The above summary is provided merely for purposes of summarizing some example embodiments to provide a basic understanding of some aspects of the invention. Accordingly, it will be appreciated that the above-described embodiments are merely examples and should not be construed to narrow the scope or spirit of the invention in any way. It will be appreciated that the scope of the invention encompasses many potential embodiments in addition to those here summarized, some of which will be further described below.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1 illustrates a network diagram of a system for auto-categorizing asset criticality using a machine learning (ML) technique in an industrial control network in accordance with an example embodiment of the present disclosure;

FIG. 2 illustrates a block diagram of the server in accordance with an example embodiment of the present disclosure;

FIG. 3 illustrates an architectural view of the industrial control network in accordance with an example embodiment of the present disclosure;

FIG. 4 illustrates a network diagram showing a selection of a plurality of asset factors associated with one or more assets of the industrial control network of the system in accordance with an example embodiment of the present disclosure;

FIG. 5 illustrates a network diagram showing one or more clusters of the one or more asset factors in accordance with an example embodiment of the present disclosure;

FIG. 6 illustrates a network diagram showing deployment of a trained ML model in the industrial control network in accordance with an example embodiment of the present disclosure;

FIG. 7 illustrates a block diagram of the industrial control network in communication with the server in accordance with an example embodiment of the present disclosure;

FIG. 8 illustrates a block diagram showing an implementation of the system with one or more other industrial control networks in accordance with an example embodiment of the present disclosure;

FIG. 9 illustrates a network diagram showing calculation of the asset criticality using the trained ML model in accordance with an example embodiment of the present disclosure;

FIG. 10 illustrates a network diagram showing response of the industrial control network against a cyber-attack using the trained ML model in accordance with an example embodiment of the present disclosure; and

FIG. 11 illustrates a flowchart showing a method for auto-categorizing asset criticality using the ML technique in the industrial control network in accordance with an example embodiment of the present disclosure.

### DETAILED DESCRIPTION

Some embodiments will now be described more fully hereinafter with reference to the accompanying drawings, in which some, but not all, embodiments are shown. Indeed, various embodiments may be embodied in many different forms and should not be construed as limited to the embodiments set forth herein; rather, these embodiments are provided so that this disclosure will satisfy applicable legal requirements.

The components illustrated in the figures represent components that may or may not be present in various embodiments of the invention described herein such that embodiments may include fewer or more components than those shown in the figures while not departing from the scope of the invention. Some components may be omitted from one or more figures or shown in dashed line for visibility of the underlying components.

The present disclosure provides various embodiments of methods and systems for auto-categorizing asset criticality using a machine learning (ML) technique in an industrial control network. Embodiments may be configured to select a plurality of asset factors associated with one or more assets of an industrial control network by at least one processor. The plurality of asset factors may correspond to a specific criteria used to access characteristics, vulnerabilities, and criticality of each of the one or more assets within the industrial control network. The plurality of asset factors may comprise at least one of an active own operational technological (OT) ports, a direct connection to known OT endpoint, an indirect connection to the OT endpoints, use of OT protocols, a number of connections to information technology (IT) endpoints, or a connection to external subnets. The one or more assets within the industrial control network may comprise at least one of programmable logic controllers (PLCs), remote terminal units (RTUs), supervisory control and data acquisition systems (SCADA), distributed control systems (DCS), one or more sensors, or actuators. Embodiments may be further configured to assign a scale factor to each asset factor of the plurality of asset factors by the at least one processor. The scale factor may define a weightage assigned to each asset factor of the plurality of asset factors. The scale factor is either assigned manually by a user or assigned automatically using artificial intelligence (AI)/ML technique.

Embodiments may be configured to create one or more clusters of the plurality of asset factors based at least on the scale factor assigned by the at least one processor. Embodiments may be configured to determine centroids from each of the one or more clusters based at least on a Euclidean distance, to train a machine learning (ML) model by the at least one processor. The centroids may be configured to uniquely define each of the one or more clusters, and wherein the Euclidean distance corresponds to a total numerical difference of coordinates of the plurality of asset factors. Embodiments may be configured to deploy the trained ML model comprising the one or more clusters having respective centroids determined, within the industrial control network to categorize an asset criticality for each of the one or more assets by the at least one processor. The asset criticality categorized for each of the one or more assets corresponds to at least one of high criticality, medium criticality, or low criticality. Embodiments may be configured to determine the asset criticality based at least on a criticality score associated with each of the one or more assets.

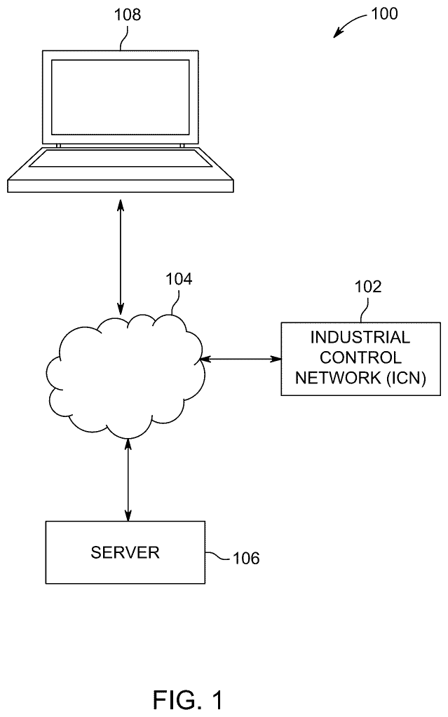

FIG. 1 illustrates a network diagram of a system 100 for auto-categorizing asset criticality using a machine learning (ML) technique in an industrial control network 102, in accordance with an example embodiment of the present disclosure. The system 100 may comprise a network 104, a server 106, and a user device 108.

In some embodiments, the system 100 may be associated with a range of industrial environments. In one example, each of the industrial environment may be implemented to perform various large-scale operations. Further, the industrial environments may include at least a large scale manufacturing plant having a plurality of processes and machineries that are involved in production of goods in a large scale. Further, the system 100 may be utilized in a large scale goods packaging facility that are involved in packaging of goods and distribution of goods. Further, the system 100 may be implemented into a traffic surveillance and monitoring systems, etc. It may be noted that these industrial environments are some potential industrial environments and the system 100 is capable of being deployed to other complex industrial processes and environments.

In some embodiments, each of the industrial environment may comprise the industrial control network 102. Further, the industrial control network 102 may be configured to control and monitor various industrial processes and operations. In some embodiments, the industrial control network 102 may be configured to facilitate a precise control and monitoring of various processes within the industrial environment. In one example, in a large-scale manufacturing plant, the industrial control network 102 may be configured to coordinate one or more operations of machineries, regulate assembly line processes, and ensure quality control measures. In another example, in a goods packaging facility, the industrial control network 102 may be configured to monitor automation of packaging lines, manage inventory systems, and optimize the workflow. In traffic surveillance and monitoring systems, the industrial control network 102 may integrate with various sensors and cameras to monitor traffic patterns, control traffic signals, and provide real-time data analysis. It may be noted that the industrial control network 102 may be referred to as an industrial control system.

In some embodiments, the industrial control network 102 may comprise one or more assets. Further, the one or more assets may be configured to perform one or more specific tasks for an efficient working of the industrial environment. In some embodiments, the one or more assets may comprise at least, one or more programmable logic controllers (PLCs), one or more remote terminal units (RTUs), supervisory control and data acquisition systems (SCADA), distributed control systems (DCS), one or more sensors, and one or more actuators. In some embodiments, the one or more assets may form an integral network that may support one or more requirements of the industrial environment. In one example, the one or more PLCs may be configured to automate machinery and processes, ensuring a precise control over the machinery and real-time adjustments within the processes.

The one or more RTUs may be configured to collect data from the one or more sensors installed within the industrial environment and transmit the data to control systems for analysis and decision-making. The SCADA may be configured to provide a centralized monitoring and control over one or more complex processes. The DCS may be configured to manage operations across different locations within the industrial environment, to provide a coordinated and efficient performance. Further, the sensors integrated within the industrial control network 102 may be configured to detect various physical parameters such as temperature, pressure, and flow rates. The actuators coupled with the machinery within the industrial control network 102 may be configured to execute commands from the control systems, such as opening valves, or starting motors.

In some embodiments, the network 104 may be a communication network, such as the internet or a cloud network, configured to enable communication between the ICN 102, the server 106, and the user device 108 through wired, wireless, or hybrid connections. Further, the network 104 may also correspond to a distributed infrastructure designed for the exchange of data, information, and resources among interconnected computing devices and systems. The network 104 may facilitate communication and collaboration across remote locations, devices, and platforms. Those skilled in the art will understand that wired devices may include, but are not limited to, wired networks such as wide area networks (WANs) or local area networks (LANs). Further, wireless devices, on the other hand, may use wireless communications via radio frequency (RF) signals or infrared signals. Furthermore, various devices within the system 100 may connect to the network 104 using an array of wired and wireless communication protocols, such as Transmission Control Protocol/Internet Protocol (TCP/IP), User Datagram Protocol (UDP), and 2G, 3G, or 4G communication protocols.

In some embodiments, the server 106 may correspond to a computer module that is configured to provide centralized resources, data, or services to the industrial control network 102. The server 106 may be configured to handle and manage one or more computational tasks and data processing within the system 100. In some embodiments, the server 106 may include storage systems, such as hard drives or storage arrays, to store and manage large volumes of data and information accessible to network users. In some embodiments, the server 106 may further provide centralized control and management capabilities, allowing network administrators to configure, monitor, and maintain network resources, security settings, and user access permissions from a single location.

In some embodiments, the server 106 may be configured to select a plurality of asset factors associated with each of the one or more assets of the industrial control network 102. Further, the plurality of asset factors may correspond to a specific criteria used to access characteristics, vulnerabilities, and criticality of each of the one or more assets within the industrial control network 102. In some embodiments, upon selecting the plurality of asset factors, the server 106 may describe an importance of each of the one or more assets in the industrial control network 102 and impact of each of the one or more assets in the industrial control network 102.

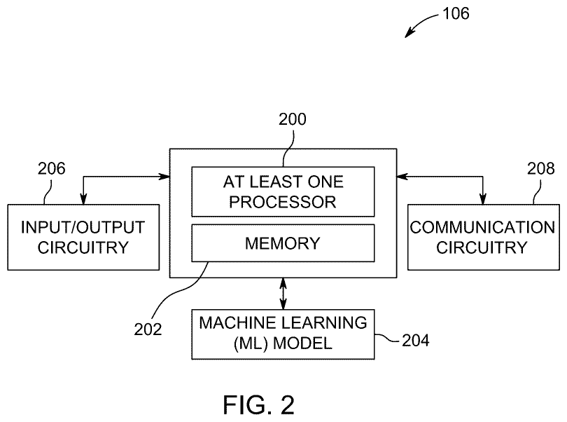

Further, the server 106 may comprise a memory (not shown) and at least one processor (not shown) communicatively coupled to the memory. The memory may be configured to store data associated with the plurality of asset factors. In some embodiments, the plurality of asset factors may comprise at least an active own operational technological (OT) ports, a direct connection to known OT endpoint, an indirect connection to the OT endpoints “e.g. wireless connections between two or more assets”, use of OT protocols “e.g. fault tolerant Ethernet (FTE) heartbeat, Delta-V, redundant network routing protocol (RNRP), Vnet/IP”, a number of connections to information technology (IT) endpoints, or a connection to external subnets “e.g. internet”. In one example, the memory may be configured to store one or more instructions that may be executed by the server to perform various operations. The detailed description of the memory and the at least one processor will be described in conjunction with FIG. 2.

In some embodiments, the server 106 may be configured to assign a scale factor to each asset factor of the plurality of asset factors. In some embodiments, the scale factor may define a weightage assigned to each asset factor of the plurality of asset factors. In some embodiments, the scale factor may be configured to quantify a relative importance of each asset factor of the plurality of asset factors. Further, the scale factor may be configured to indicate contribution of each asset factor of the plurality of asset factors in determining importance and impact of each of the one or more assets.

In some embodiments, the server 106 may be configured to create one or more clusters of the plurality of asset factors, based at least on the scale factor assigned. In some embodiments, the one or more clusters of the plurality of asset factors may comprise one or more groups of asset factors of the plurality of asset factors having similar impact or importance level as represented by corresponding scale factor assigned. In some embodiments, the one or more clusters of the plurality of asset factors may be configured to provide interrelationships and dependencies among each of the plurality of asset factors.

In some embodiments, the server 106 may further be configured to determine centroids from each of the one or more clusters based at least on a Euclidean distance. In some embodiments, the centroids may be configured to uniquely define each of the one or more clusters. In some embodiments, the server 106 may be configured to determine the centroids from each of the one or more clusters, based at least on a Euclidean distance, to train a machine learning (ML) model. Further, the Euclidean distance may correspond to a total numerical difference of coordinates of the plurality of asset factors. Further, the server 106 may be configured to deploy the trained ML model within the industrial control network 102. Further, the trained ML model may comprise the one or more clusters having respective centroids determined.

In some embodiments, the server 106 may be configured to determine the asset criticality based at least on a criticality score associated with each of the one or more assets. Further, the asset criticality categorized for each of the one or more assets may correspond to at least one of a high criticality, medium criticality, or low criticality. In some embodiments, the one or more assets having high criticality may have a higher impact on the industrial control network 102. In some embodiments, the one or more assets having low criticality may have a lowest impact on the industrial control network 102. In some embodiments, the one or more assets having medium criticality may have a lower impact on the industrial control network 102 when compared to the one or more assets having the high criticality.

In some embodiments, the system 100 may comprise the user device 108. Further, the user device 108 may be communicatively coupled to the industrial control network 102 through the network 104. In one examples, the user device 108 may be configured to display the asset criticality score associated with each asset of the plurality of assets in the industrial control network 102. In some embodiments, the user device 108 may be configured to provide a real-time insight into criticality and status of each asset of the one or more assets of the industrial control network 102. Further, the user device 108 may comprise at least one of a mobile phone, tablet, laptop, etc. Further, the user device 108 may be installed with a user interface that may provide a medium to the user to manually provide the asset criticality score.

It will be apparent to one skilled in the art that above-mentioned components of the system 100 have been provided only for illustration purposes, without departing from the scope of the disclosure.

FIG. 2 illustrates a block diagram of the server 106, in accordance with an example embodiment of the present disclosure. FIG. 2 is described in conjunction with FIG. 1. In some embodiments, the server 106 may comprise at least one processor 200, a memory 202, a machine learning (ML) model 204, an input/output circuitry 206, and a communication circuitry 208.

In some embodiments, the at least one processor 200 may include suitable logic, circuitry, and/or interfaces that are operable to execute one or more instructions stored in the memory 202 to perform predetermined operations. In one embodiment, the at least one processor 200 may be configured to decode the one or more instructions and execute the one or more instructions that are stored within the memory 202. The at least one processor 200 may be configured to execute one or more computer-readable program instructions, such as program instructions to carry out any of the functions described in this description. Further, the at least one processor 200 may be implemented using one or more processor technologies known in the art such as central processing unit (CPU), field-programmable gate array (FPGA), digital signal processors (DSP), etc. Examples of the at least one processor 200 may comprise at least one of, one or more general purpose processors and/or one or more special purpose processors that may be designed to handle the industrial control network 102.

In some embodiments, the at least one processor 200 may be configured to select the plurality of asset factors that may be associated with the one or more assets of the industrial control network 102. In some embodiments, the plurality of asset factors may correspond to the specific criteria used to access characteristics, vulnerabilities, and criticality of each of the one or more assets within the industrial control network 102. Further, the plurality of asset factors may comprise at least one of an active own operational technological (OT) ports, a direct connection to known OT endpoint, an indirect connection to the OT endpoints, use of OT protocols, a number of connections to information technology (IT) endpoints, or a connection to external subnets.

In some embodiments, the active own operational technological (OT) ports may refer to a number of active ports on the one or more assets. Further, the active own OT ports may be used for operational functions. Further, the active own OT ports may facilitate interaction of each of the one or more assets with other external devices and systems within the industrial control network 102. In some embodiments, the direct connection to known OT endpoint may be configured to indicate a direct connection of the one or more assets to an OT endpoint. In one example, the direct connection of the one or more assets may correspond to a faster and impactful role of the one or more assets within the industrial control network 102.

In some embodiments, the indirect connection to the OT endpoints may involve connections that may indirectly link the one or more assets to OT endpoints through intermediate devices or networks. In some embodiments, the use of OT protocols may be configured to determine whether the one or more asset utilized specific protocols designed for operational technology. Further, the OT protocols may be specially designed for various industrial environments. In some embodiments, the number of connections to IT endpoints may specify a number of IT systems that are connected with the one or more assets. In some embodiments, the connection to external subnets may assesses whether the one or more assets are connected to external subnets.

In some embodiments, the at least one processor 200 may be configured to assign the scale factor to each asset factor of the plurality of asset factors. In some embodiments, the scale factor may correspond to the weightage assigned to each asset factor of the plurality of asset factors. In some embodiments, the scale factor may define importance of each asset factor of the plurality of asset factors. In one example, the scale factor may be assigned manually by a user. Further, the user device 108 associated with the system 100 may facilitate the user to assign the scale factor to each asset factor. In some embodiments, the user device 108 may be configured to provide the user interface that may enable the user to assign the scale factor to each of the plurality of assets. Further, the user interface may comprise a plurality of dynamic features such as drag-and-drop functionality, sliders, and input fields.

In another example, the scale factor may be assigned automatically using artificial intelligence (AI)/ML technique. The AI/ML technique may facilitate the at least one processor 200 to receive and process a large amount data having the plurality of asset factors of the one or more assets of the industrial control network 102. The AI/ML techniques may involve collecting and preprocessing the data, selecting appropriate models, training the models based on the plurality of asset factors of each of the one or more assets of the industrial control network 102 to determine the scale factor. In some embodiments, the models of the AI/ML technique may comprise at least, regression analysis, random forests and gradient boosting machines (GBMs), clustering algorithms, principal component analysis (PCA), Q-learning and deep Q-networks (DQNs), auto-encoders and isolation forests, convolution neural networks (CNNs) and recurrent neural networks (RNNs), deep belief networks (DBNs), and text mining and sentiment analysis.

In some embodiments, the at least one processor 200 may be configured to create the one or more clusters of the plurality of asset factors based at least on the scale factor assigned. In some embodiments, the one or more clusters of the plurality of asset factors may comprise the one or more groups of asset factors of the plurality of asset factors having similar impact or importance level as represented by corresponding scale factor assigned. In some embodiments, the asset factors from the plurality of asset factors having similar importance or influence on the industrial control network 102 may be organized into same cluster from the one or more clusters. In one example, the asset factors “active own operational technological (OT) ports” and “direct connection to known OT endpoint” may have a similar importance on the industrial control network 102, thereby the at least one processor 200 may organize the asset factors “active own operational technological (OT) ports” and “direct connection to known OT endpoint” into one cluster of the one or more clusters. It will be apparent to one skilled in the art that above-mentioned plurality of asset factors have been provided only for illustration purposes, without departing from the scope of the disclosure.

In some embodiments, the scale factor for each asset factor may be configured to allow a spatial distance between the one or more clusters and eliminate errors induced by intersections of the one or more clusters. By assigning appropriate scale factors, the at least one processor 200 may ensure that each of the one or more clusters of the plurality of asset factors may be well-defined and distinctly separated from others. Further, the spatial distance between the one or more clusters may reduce a risk of errors that may arise from the one or more clusters intersecting or blending together.

In some embodiments, the at least one processor 200 may be configured to determine centroids from the one or more clusters based at least on the Euclidean distance. Further, the Euclidean distance may correspond to a total numerical difference of coordinates of the plurality of asset factors. Further, the at least one processor 200 may be configured to determine a central position of each of the plurality of asset factors within each of the one or more clusters. In some embodiments, the centroids of each of the one or more clusters may define a reference point within each of the cluster that may further provide an average position of each of the plurality of asset factors within each of the one or more clusters.

In some embodiments, the at least one processor 200 may be configured to train the ML model 204, based at least on the determined centroids. In some embodiments, the centroids of plurality of asset factors of each of the one or more cluster may facilitate the ML model 204 to learn and recognize patterns, based at least on the determined centroid. In some embodiments, the at least one processor 200 may be configured to perform one or more operations to train the ML model 204. Further, the one or more operations may include, but are not limited to, data collection, initial clustering, determining centroids, pattern recognition, testing, and validation. Further, during the training process, the ML model 204 may be configured to collect the centroids of each of the one or more clusters over time to identify and learn patterns within the plurality of asset factors. Further, the training process may involve analyzing relationships and correlations between various data points that may represent operational conditions and performance of the corresponding one or more assets in the industrial control network 102.

For example, an industrial control network 102 includes a plurality of sensors that may be configured to monitor different parameters like temperature, vibration, and pressure. Further, at least one processor 200 of the industrial control network 102 creates one or more clusters of data received from the plurality of sensors, based on similarity and impact of the plurality of sensors. Further, the at least one processor 200 calculates centroids for each of the one or more clusters to represent an average conditions of the plurality of sensors of a particular cluster.

Further, the trained ML model 204 may be configured to examine the centroids to understand a typical behavior and operational states of the one or more assets within each cluster in the industrial control network 102. Further, the trained ML model 204 may be configured to look for patterns and trends that may indicate normal or abnormal conditions. For example, the trained model 204 may learn that a steady temperature combined with a low vibration is a normal operational state for a piece of machinery. Further, the trained ML model 204 may be configured to identify that an increase in the temperature along with a high vibration levels is a pattern that may be result of a machinery malfunctions or failures.

In some embodiments, based at least on the recognized patterns, the trained ML model 204 may be configured to make informed predictions associated with the one or more assets. In one instance, when the system 100 may detect a rise in temperature and increased vibration in real-time data via the trained ML model 204, the server 106 may alert operators to a potential malfunction of the piece of machinery or a cyberattack on the industrial control network 102. Further, the predictive nature of the system 100 facilitates a proactive maintenance, reducing a downtime and preventing potential damage to the one or more assets.

In some embodiments, the at least one processor 200 may be configured to deploy the trained ML model 204 within the industrial control network 102. Further, the trained ML model 204 may comprise respective centroids determined by the Euclidean distance. Further, by deploying the trained ML model 204, the industrial control network 102 may be configured to categorize the asset criticality for each of the one or more assets. Further, the asset criticality categorized for each of the one or more assets may correspond to at least one of the high criticality, the medium criticality, or the low criticality. Further, by incorporating the trained ML model 204, the system 100 may enhance its ability to predict and classify the plurality of asset factors.

In some embodiments, the at least one processor 200 may further be configured to determine the asset criticality score associated with each of the one or more assets. Further, the asset criticality score may define a quantitative measure that may reflect how crucial an asset from the one or more assets is to an overall operation of the industrial control network 102. Further, the asset criticality score may facilitate prioritization of maintenance, upgrades, a resource allocation ensuring that a most critical asset of the one or more assets may receive an optimum attention.

In some embodiments, the memory 202 may be configured to store a set of instructions and data executed by the at least one processor 200. Further, the memory 202 may include the one or more instructions that are executable by the at least one processor 200 to perform specific operations. The memory 202 may be configured to include the instructions to select the plurality of asset factors associated with the one or more assets of the industrial control network 102. The memory 202 may be configured to include the instructions to assign the scale factor to each asset factor of the plurality of asset factors. Further, the memory 202 may be configured to include the instructions to create the one or more clusters of the plurality of asset factors based at least on the scale factor assigned. The memory 202 may be configured to include the instructions to determine centroids from each of the one or more clusters based at least on the Euclidean distance, to train the ML model 204. The memory 202 may be configured to include the instructions to deploy the trained ML model 204 comprising the one or more clusters having respective centroids determined, within the industrial control network 102 to categorize the asset criticality for each of the one or more assets. Thereafter, the memory 202 may be configured to include the instructions to determine the asset criticality based at least on the criticality score associated with each of the one or more assets.

The memory 202 may be configured to include the plurality of asset factors associated with the one or more assets of the industrial control network 102. It is apparent to a person with ordinary skill in the art that the one or more instructions stored in the memory 202 enable the hardware of the system 100 to perform the predetermined operations. Some of the commonly known memory 202 implementations include, but are not limited to, fixed (hard) drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other type of media/machine-readable medium suitable for storing electronic instructions.

In some embodiments, the server 106 may further comprise the input/output circuitry 206. The input/output circuitry 206 may enable the user to communicate or interface with the system 100, via the user device 108. The user device 108 may include N number of user devices. In some embodiments, the input/output circuitry 206 may act as a medium to transmit input from the interface to and from the server 106. In some embodiments, the input/output circuitry 206 may refer to the hardware and software components that facilitate the exchange of information between the user device 108 and the server 106. In one example, the server 106 may include the application as an input circuitry to allow the one or more users to provide an input request to assign the scale factor. The input/output circuitry 206 may include various input devices such as keyboards, barcode scanners, GUI for the one or more users to provide data and various output devices such as displays, printers for the one or more users to receive data. In another example, the input/output circuitry 206 may include various output circuitry such as a display.

In some embodiments, the server 106 may further comprise the communication circuitry 208. The communication circuitry 208 may allow the server 106 to exchange data or information with the user device 108, other systems or apparatuses. Further, the communication circuitry 208 may include network interfaces, protocols, and software modules responsible for sending and receiving data or information from the user device 108. In some embodiments, the communication circuitry 208 may include Ethernet ports, Wi-Fi adapters, or communication protocols like HTTP or MQTT for connecting with other systems. The communication circuitry 208 may further include components such as communication modules (e.g., Wi-Fi, Ethernet, cellular), transceivers, antennas, and protocols (e.g., TCP/IP, MQTT, SNMP) for exchanging data with the user device 108 and the other systems. The communication circuitry 208 may allow the server 106 to stay up-to-date.

It will be apparent to one skilled in the art the above-mentioned components of the server 106 have been provided only for illustration purposes, without departing from the scope of the disclosure.

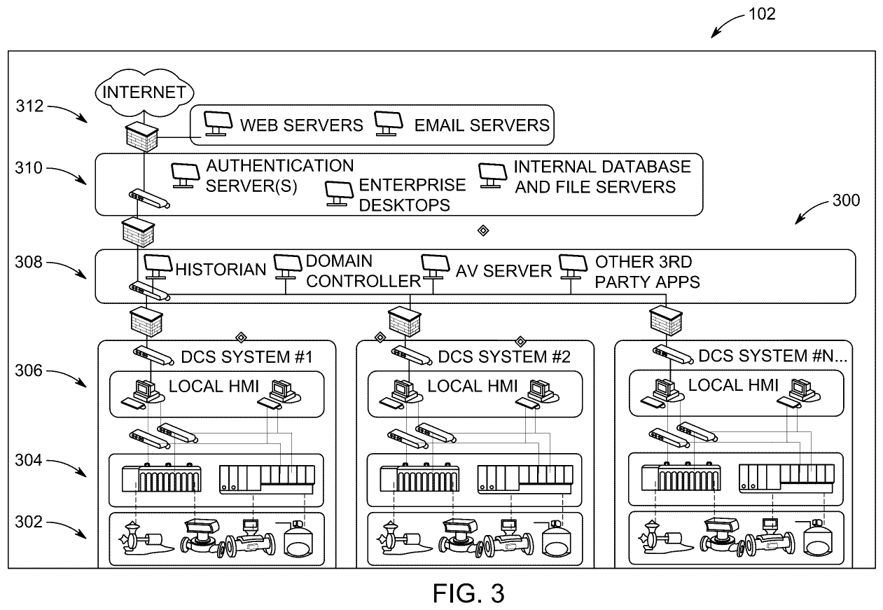

FIG. 3 illustrates an architectural view of the industrial control network 102, in accordance with an example embodiment of the present disclosure. FIG. 3 is described in conjunction with FIGS. 1-2.

In some embodiments, the industrial control network 102 may comprise one or more assets 300 that may be configured to execute respective tasks. Further, the one or more assets 300 may be organized in a hierarchal order. Further, the hierarchal order of the one or more assets 300 of the industrial control network 102 may be organized in a plurality of levels. For example, level-0 302, level-1 304, level-2 306, level-3 308, level-4 310, level-5, 312, and level-n. Further, each level of the plurality of levels of the industrial control network 102 may be configured to perform at least one specific operation in combination. Further, the at least one specific operation may comprise a process operation, a control operation, a supervisory operation, an operations (Ops) admin operation, an enterprise admin operation and an internet demilitarized zone (DMZ) operation.

In one example, when the level-0 302 of the industrial control network 102 corresponds to the process operation, the one or more assets 300 of the level-0 302 may comprise a plurality of field devices such as motors, pumps, valves, drives, generators, sensors, actuators, etc. Further, the one or more assets 300 of the level-0 302 may be operated through a plurality of hard-wired connections. In another example, when the level-1 304 of the industrial control network 102 correspond to the control operation, the one or more assets 300 of the level-1 304 may comprises one or more controllers such as the programmable logic controllers (PLCs), remote terminal units (RTUs), supervisory control and data acquisition systems (SCADA), etc. Further, the one or more assets 300 of the level-1 304 may be configured to control operations of the one or more assets 300 of level-0 302. In some embodiments, the one or more assets 300 of the level-1 304 may be calibrated or programmed to control operations of the one or more assets 300 of the level-0 302.

In another example, when the level-2 306 of the industrial control network 102 correspond to the supervisory operation, the one or more assets 300 of the level-2 306 may comprise one or more local human-machine interfaces (HMIs). Further, the one or more HMIs may be configured to facilitate programming of the one or more assets 300 of the level-1 306 of the industrial control network 102. Further, the HMIs may be installed with at least one of a user interface (UI)/application programmable interface (API). In some embodiments, the one or more assets 300 of the level-0 302, level-1 304, and level-2 306 may provide one or more distributed control systems (DCS). In one example, the industrial control network 102 may comprise one or more DCS such as DCS system-1, DCS system-2, DCS system-3, . . . , DCS system-n.

In another example, when the level-3 308 of the industrial control network 102 correspond to ops admin operation, the one or more assets 300 of the level-3 308 may comprise one or more primary databases such as historian, domain controller, AV server, and other third-party applications. Further, the one or more assets 300 of the level-3 308 may be configured to ensure integrity, security, and efficiency of the industrial control network 102. In some embodiments, each of the one or more assets 300 of the level-3 308 of the industrial control network 102 may be connected with the one or more DCS systems of the industrial control network 102 through Ethernet, TCP/IP protocols.

In another example, when the level-4 310 of the industrial control network 102 correspond to enterprise admin operation, the one or more assets 300 of the level-4 310 may comprise one or more secondary databases such as authentication server(s), enterprise desktops, and internal data module/file servers. In some embodiments, the one or more assets 300 of the level-4 310 of the industrial control network 102 may be configured to receive and process data received from the one or more assets 300 of the level-3 308 of the industrial control network 102 and the one or more DCS systems. In another example, when the level-5 312 of the industrial control network 102 correspond to the internet demilitarized zone (DMZ) operation, the one or more assets 300 of the level-5 312 may comprise one or more servers such as web servers and email servers. Further, the one or more assets 300 of the level-5 312 of the industrial control network 102 may be connected to internet.

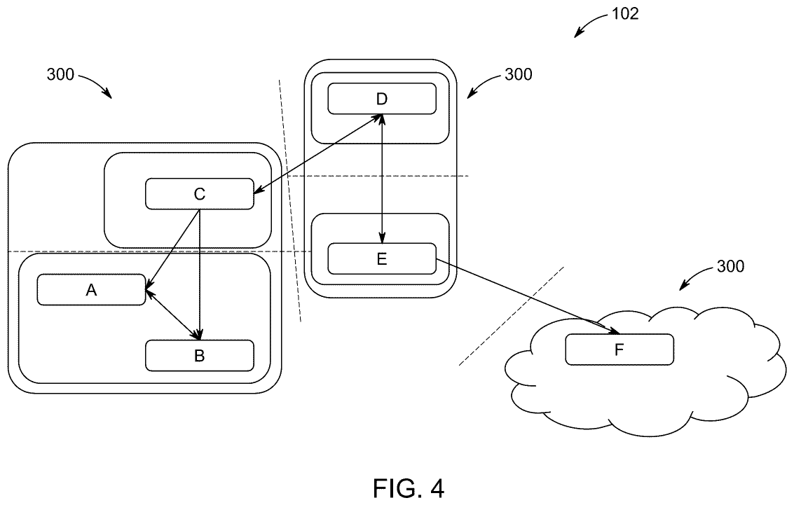

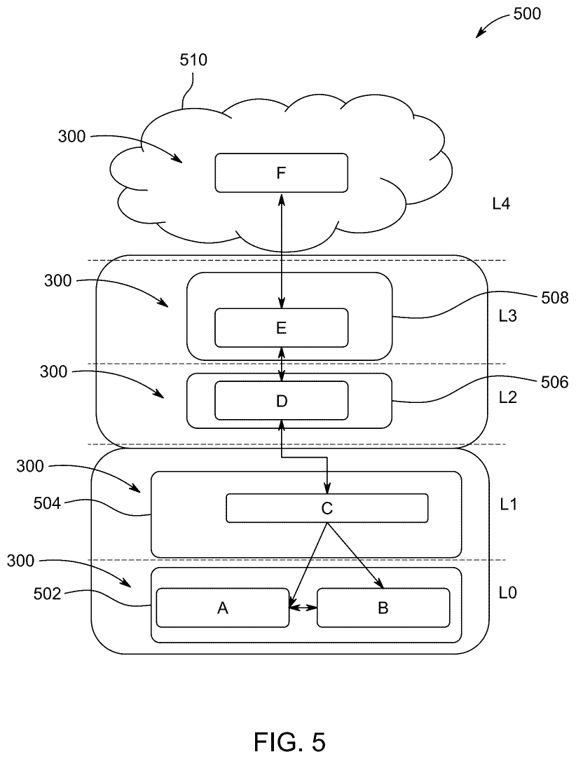

FIG. 4 illustrates a network diagram showing a selection of the plurality of asset factors associated with the one or more assets 300 of the industrial control network 102 of the system 100, in accordance with an example embodiment of the present disclosure. FIG. 5 illustrates a network diagram showing one or more clusters 500 of the one or more asset factors, in accordance with an example embodiment of the present disclosure. FIGS. 4-5 are described in conjunction with FIGS. 1-3.

In some embodiments, the one or more assets 300 of the industrial control network 102 may comprise asset-A, asset-B, asset-C, asset-D, asset-E, and asset-F. Further, the at least one processor 200 of the system 100 may be configured to select the plurality of asset factors associated with the one or more assets 300 of the industrial control network 102. In one example, the plurality of asset factors may comprise at least the active own operational technological (OT) ports, the direct connection to known OT endpoint, the indirect connection to the OT endpoints “e.g. wireless connections between two or more assets”, the use of OT protocols “e.g. fault tolerant Ethernet (FTE) heartbeat, Delta-V, redundant network routing protocol (RNRP), Vnet/IP”, the number of connections to information technology (IT) endpoints, and the connection to external subnets “e.g. internet connection.

Further, the at least one processor 200 may be configured to assign the scale factor to each asset factor of the plurality of asset factors of the industrial control network 102. In one example, the scale factor may be assigned for the active own operational technological (OT) ports=500, a direct connection to known OT endpoint=300, an indirect connection to the OT endpoints=150, use of OT protocols=300, a number of connections to information technology (IT) endpoints=3 values (5, 10, 15), or a connection to external subnets=30. In another example, the scale factor for the active own operational technological (OT) ports=, a direct connection to known OT endpoint=200, an indirect connection to the OT endpoints=165, use of OT protocols=250, a number of connections to information technology (IT) endpoints=3 values (3, 8, 12), or a connection to external subnets=23.

In some embodiments, the at least one processor 200 may be configured to create the one or more clusters of the plurality of asset factors. Further, the one or more clusters may comprise at least one combination of the plurality of asset factors. In one example, the one or more clusters may comprise a first combination of the plurality of asset factors “e.g. the active own OT ports+target IT IPs+external subnets (i.e. internet)”, “target OT IPs”. In another example, the one or more clusters may comprise a second combination of the plurality of asset factors “e.g. target OT IPs and/or special OT protocols+target IT IPs+external subnets (i.e. internet)”. In another example, the one or more clusters may comprise a third combination of the plurality of asset factors “e.g. OT indirect+target IT IPs+external subnets (i.e. internet)”. In another example, the one or more clusters may comprise a fourth combination of the plurality of asset factors “e.g. target IT IPs+external subnets (i.e. internet)”.

In some embodiments, the at least one processor 200 may be configured to create the one or more clusters of the plurality of asset factors based at least on the scale factor assigned. Further, the at least one processor 200 may be configured to create the one or more clusters for the asset factors of the plurality of asset factors having similar impact or importance level as represented by corresponding scale factor assigned. In some embodiments, each combination of the one or more clusters may define a range of scale factors. In one example, the first combination of the one or more clusters may define a range of 500-545 scale factor. In another example, the second combination of the one or more clusters may define a range of 300-345 scale factor. In another example, the third combination of the one or more clusters may define a range of 155-195 scale factor. In another example, the fourth combination of the one or more clusters may define a range of 35-45 scale factor.

In some embodiments, each of the one or more clusters may be defined by a “K-means”. Further, the at least one processor 200 may be configured to run at least one pseudo code to determine the K-means defined by the one or more clusters. In one example, the K-means for each combination of the one or more clusters is 4. Further, the K-means may be configured to facilitate the at least one processor 200 to assign other subsequent assets to be added into the one or more clusters. Further, the K-means may be configured to define at least four possible classes. In some embodiments, the at least one processor 200 may be configured to train the ML model 204 through the determined centroids of each of the one or more clusters.

In some embodiments, the scale factor for each asset factor may be provided to maintain a spatial distance between the one or more clusters, that may prevent errors caused by intersection of the one or more clusters. By assigning the scale factors, the at least one processor 200 may ensure that each of the one or more clusters of the plurality of asset factors may be well-defined and distinctly separated from the others. Further, the spatial distance between the one or more clusters may minimize the risk of errors that may result from clusters overlapping or merging together.

As illustrated in FIG. 5, the at least one processor 200 may be configured to categorize the one or more clusters 500 into the at least four possible classes. In some embodiments, the at least one processor 200 may be configured to determine the centroids from each of the one or more clusters 500. Further, the at least one processor 200 may be configured to determine centroids from each of the one or more clusters 500, based at least on the Euclidean distance. Further, the level-0 302 may be referred as “L0”, the level-1 304 may be referred as “L1”, the level-2 306 may be referred as “L2”, the level-3 308 may be referred as “L3”, and the level-4 310 may be referred as “L4”. In one example, the one or more clusters 500 may comprise a cluster-1 502, a cluster-2 504, a cluster-3 506, a cluster-4 508, and a cluster-5 510. In some embodiments, the plurality of levels of the industrial control network may correlate with the one or more clusters 500. Further, the cluster-1 502 may comprise the asset-A and the asset-B. Further, the asset-A and the asset-B may be interdependent. Further, the cluster-2 504 may comprise the asset-C. Further, the asset-C may be dependent on the asset-A and the asset-B. In some embodiments, the cluster-3 506 may comprise the asset-D. Further, the asset-C and the asset-D may be interdependent. Further, the cluster-4 508 may comprise the asset-E. Further, the asset-E may be interdependent on the asset-D. Further, the cluster-5 510 may comprise the asset-F. Further, the asset-F may be interdependent on the asset-E.

In another example, the industrial control network 102 may comprise the one or more clusters 500. Further, the one or more clusters 500 may comprise an M0-cluster, an M1-cluster, an M2-cluster, an M3-cluster, and an M4-cluster. Further, the M0-cluster may comprise the asset-X and the asset-Y. Further, the asset-X and the asset-Y may be interdependent, meaning that changes or malfunctions in the asset-X may directly affect the functionality of the asset-Y. Further, the M1-cluster may comprise the asset-Z. Further, the asset-Z may be dependent on the asset-X and the asset-Y, indicating that operations of asset-Z may rely on the proper functioning of the asset-X and the asset-Y. In some embodiments, the M2-cluster may comprise the asset-W. Further, the asset-Z and the asset-W may be interdependent, meaning that the asset-Z and the asset-W may influence each other's performance and reliability. Further, the M3-cluster may comprise the asset-V. Further, the asset-V may be interdependent on the asset-W, indicating a critical linkage where the operational status of one directly impacts the other. Further, the M4-cluster may comprise the asset-U. Further, the asset-U may be interdependent on the asset-V, highlighting a dependency where the effectiveness and efficiency of the asset-U may impact the performance of the asset-V.

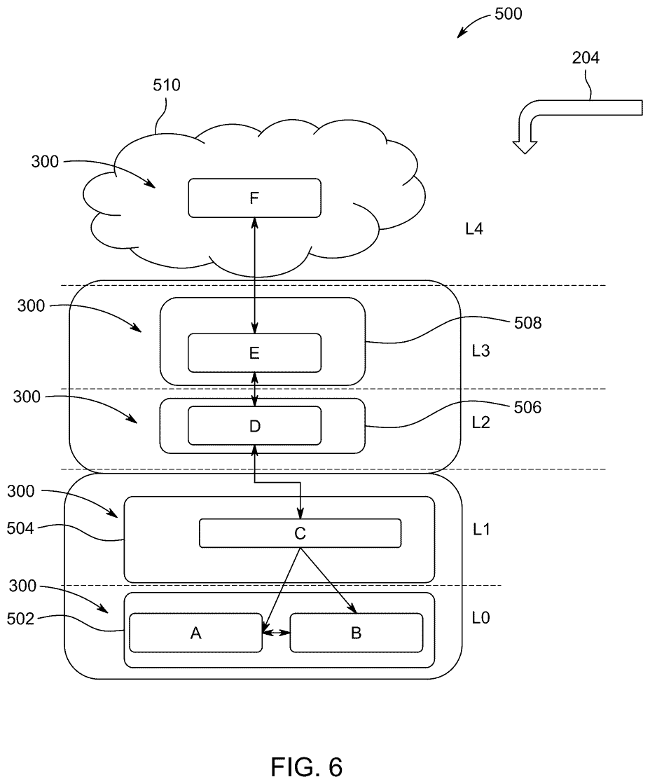

FIG. 6 illustrates a network diagram showing deployment of the trained ML model 204 in the industrial control network 102, in accordance with an example embodiment of the present disclosure.

In some embodiments, the at least one processor 200 may be configured to deploy the trained ML model 204 comprising the one or more clusters 500 having respective centroids within the industrial control network 102 to categorize the asset criticality for each of the one or more assets 300. Further, the categorization of the one or more assets 300 may enable the trained ML model 204 to evaluate the asset criticality. Further, the at least one processor 200 by using the trained ML model 204 may facilitate to determine the asset criticality with a higher degree of precision. Further, based at least on the determined centroids of the one or more clusters 500, the at least one processor 200 may determine impact of the one or more assets 300 of each cluster of the industrial control network 102. Further, the determination of the impact of the one or more assets 300 may involve analyzing positional relationships and functional dependencies among the one or more assets 300. Further, the impact of the one or more assets 300 on the industrial control network 102 may be defined as direct impact, indirect impact, no impact, and process impact.

In some embodiments, the one or more assets 300 of the cluster-2 504 and the one or more assets 300 of the cluster-3 506 of the industrial control network 102 may be configured to have the direct impact on the industrial control network 102. Further, the direct impact may signify that changes or disruptions of the one or more assets 300 of the cluster-2 504 may immediately and significantly impact one or more operations of the industrial control network 102. In some embodiments, the one or more assets 300 of the cluster-3 506 may have the indirect impact on the industrial control network 102. Further, the indirect impact may indicate that the one or more assets 300 of the cluster-3 506 may have influence, while not immediate, but may propagate through the industrial control network 102 over time. In some embodiments, the one or more assets 300 of the cluster-4 508 may have no impact on the industrial control network 102. Further, the one or more assets 300 of the cluster-4 508 may be typically peripherals or redundant, such that the changes or disruptions of the one or more assets 300 of the cluster-4 508 may be affect the one or more operations of the industrial control network 102. In some embodiments, the one or more assets 300 of the cluster-5 510 may have a process impact on the industrial control network 102. In some embodiments, the one or more assets 300 of the cluster-5 510 may influence specific operations of the industrial control network 102.

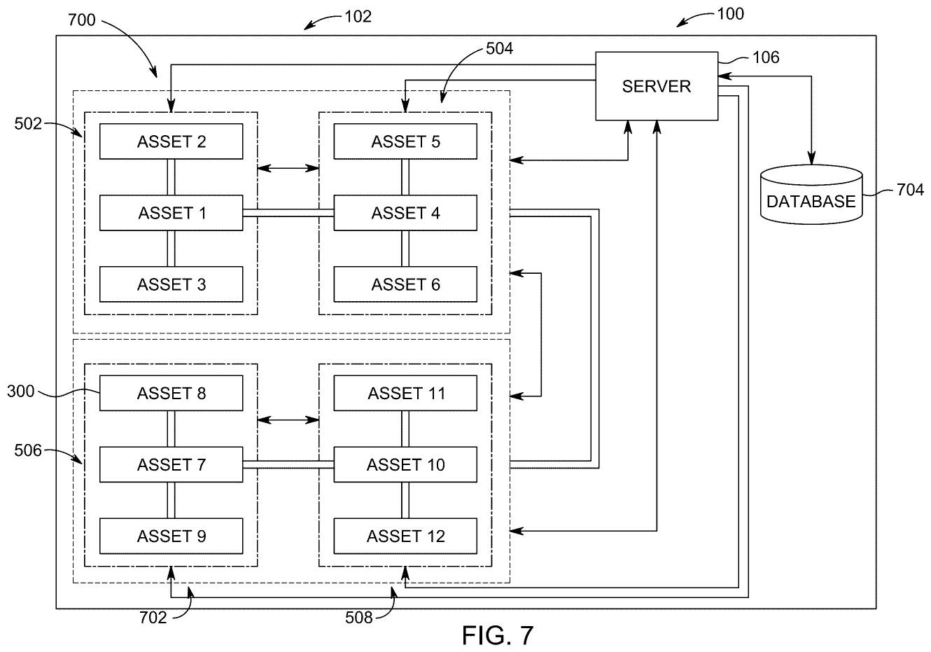

FIG. 7 illustrates a block diagram of the industrial control network 102 in communication with the server 106, in accordance with an example embodiment of the present disclosure.

In some embodiments, the one or more industrial environments may comprise one or more areas such as area-1 700, and area-2 702. Further, each area of the one or more areas may comprise the one or more clusters 500 such as the cluster-1 502, cluster-2 504, cluster-3 506, cluster-4 508. Further, each cluster of the one or more areas may further comprise the one or more assets 300. Further, the one or more industrial environments may comprise the industrial control network 102. In some embodiments, the area-1 700 of the one or more industrial environments may be interdependent on the area-2 702. Further, each cluster of the one or more clusters 500 of each of the one or more areas may be interdependent. In one example, the cluster-1 502 of the area-1 700 is interdependent on cluster-2 504 of the area-1 700. In another example, the cluster-3 506 of the area-2 702 is interdependent on cluster-4 508 of the area-2 702.

In some embodiments, each of the one or more areas of the industrial environment may be connected with the industrial control network 102. Further, each cluster of the one or more clusters 500 may be connected with the server 106 of the industrial control network 102. In some embodiments, the industrial control network 102 may be connected with a database 704 via the server 106. Further, the database 704 may serve as a medium that manages an array of data and processes integral to the one or more operations of the industrial control network 102. Further, the database 704 may be configured to provide a storage medium to the industrial control network 102. Further, the database 704 may facilitate the system 100 to store the trained ML model 204. In some embodiments, the database 704 may be configured to support the at least one processor 200 while deploying the trained ML model 204 into the industrial control network 102. In some embodiments, the trained ML model 204 contained within the database 704 may be configured to determine the asset criticality of each of the one or more assets 300 of the industrial environment.

In some embodiments, the server 106 by using the database 704 stored with the trained ML model 204, may be configured to categorize the asset criticality for each of the one or more assets 300 within the cluster-1 502, cluster-2 504, cluster-3 506, cluster-4 508, and cluster-5 510. Further, the asset criticality categorized for each of the one or more assets 300 may correspond to at least one of the high criticality, the medium criticality, or the low criticality. Further, by incorporating the trained ML model 204, the system 100 may enhance its ability to predict and classify the plurality of asset factors.

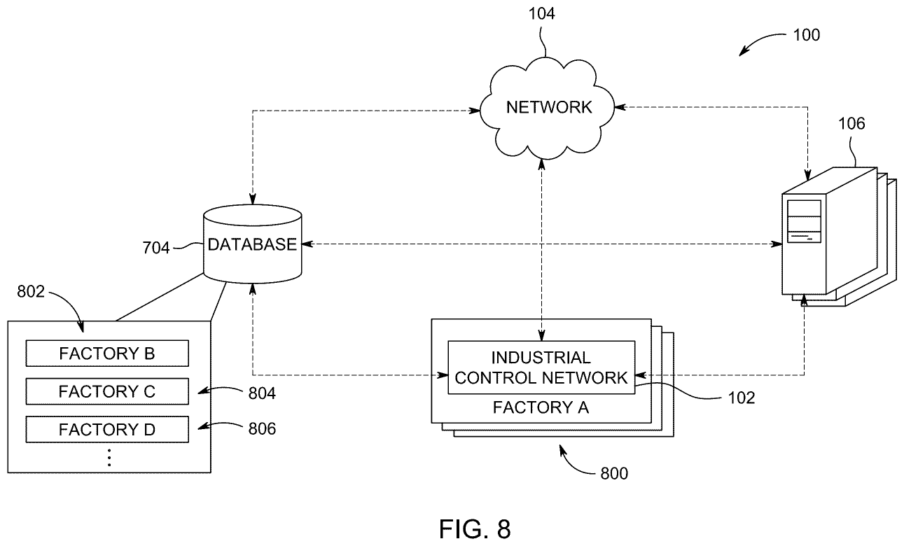

FIG. 8 illustrates a block diagram showing an implementation of the system 100 with one or more other industrial control networks, in accordance with an example embodiment of the present disclosure.

In some embodiments, the industrial control network 102 may comprise the one or more assets 300. Further, the industrial control network 102 may be installed within a Factory-A 800. Further, the one or more assets 300 may correspond to automation machinery, robotic arms, and conveyor systems. In one example, the Factory-A 800 may correspond to a large scale manufacturing factory. Further, the industrial control network 102 of the Factory-A 800 may be communicatively coupled with the server 106 and the network 104. Further, the server 106 may be configured to train the ML model 204 for categorizing the asset criticality using the one or more assets 300 of the Factory-A 800. Further, the trained ML model 204 may be stored into the database 704 by the server 106 via the network 104. Further, the database 704 may be configured to store other historical data that may be fed to the ML model 204 during training of the ML model 204 to ensure that the trained ML model 204 may be updated and refined with new data.

Further, the database 704 may be coupled with an industrial control network (not shown) of another facility Factory-B 802 through another server (not shown). Further, the Factory-B 802 may correspond to a small-scale packing factory. Further, the Factory-B 802 may comprise one or more assets 300 that may be designed to perform one or more specific operations such as labeling, boxing, and palletizing products. In some embodiments, the database 704 stored with the ML model 204 may further be deployed into another server of the Factory-B 802. The another server by using the deployed ML model 204 may be configured to categorize an asset criticality of the one or more assets 300 of the Factory-B 802.

Further, the database 704 may be coupled with an industrial control network of a Factory-C 804 through another server (not shown). Further, the Factory-C 804 may correspond to a mid-scale refinery. Further, the Factory-C 804 may comprise one or more assets 300 that may be designed to perform one or more specific operations. In some embodiments, the database 704 stored with the ML model 204 may further be deployed into another server of the Factory-C 804. The another server by using the deployed trained ML model 204 may be configured to categorize an asset criticality of the one or more assets 300 of the Factory-C 804. Further, the database 704 may be coupled with an industrial control network of a Factory-D 806 through another server (not shown). Further, the Factory-D 806 may correspond to a small-scale inventory. Further, the Factory-D 806 may comprise one or more assets 300 that may be designed to perform one or more specific operations. In some embodiments, the database 704 stored with the ML model 204 may further be deployed into another server of the Factory-D 806. The another server by using to the deployed ML model 204 may be configured to categorize an asset criticality of the one or more assets 300 of the Factory-D 806.

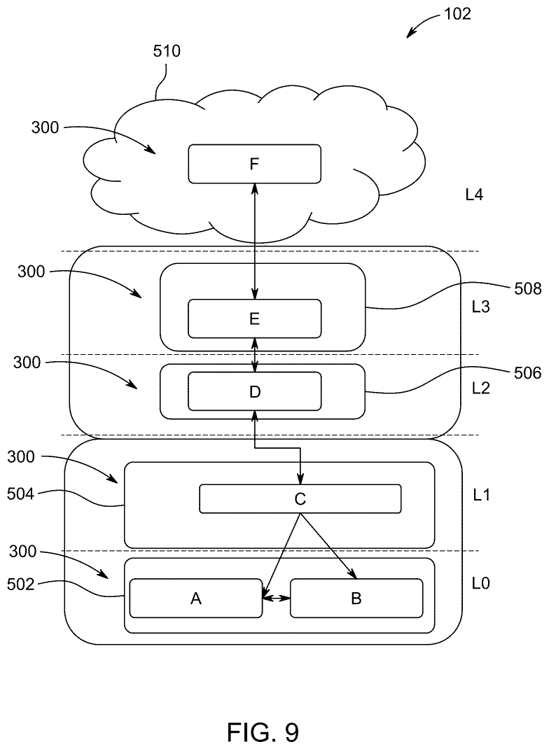

FIG. 9 illustrates a network diagram showing calculation of the asset criticality using the trained ML model 204, in accordance with an example embodiment of the present disclosure.

In some embodiments, the network diagram comprises the one or more clusters 500 each having the one or more assets 300 of the industrial control network 102. Further, the trained ML model 204 may be deployed into the system 100 to calculate the asset criticality. Further, the asset criticality may be calculated by using one or more formulas:

$$Criticality score validity : V = min ( 1 , \sum abs ( Wi - Wy ) ) for y ∈ [ 0 : n - connections ]$$

$$Criticality calculation : CR i = V * ( \sum ( max ( 0 , Wi - Wy ) ) + 1 ) for y ∈ [ 0 : n - connections ] )$$

$$Boost ( set critical to any non - L 3 Internet connection ) : B = max ( Wx - Wy - 1 , 0 ) * High$$

In one example, when an industrial control network 102 comprises one or more assets 300 (i.e., L1 and L2). The asset criticality may be calculated by considering a number of connection of each of the asset and types of connection of each of the asset. Further, the asset criticality may be determined based at least on base value (i.e. K-means)-B, and validity factor-V. Further, the each of the asset may comprise at least 5 connections with same or lower layer. Further, for calculation of the asset criticality the base weight may be considered as 5. Further, the base weight of asset with medium criticality may be considered as 5. Further, the base weight of assets with high criticality may be considered as 10. Example calculations:

In one instance, when L2-asset may comprise 1×L1, 3×L2, and 3×L3 connections:

$$B = ( max ( 2 - 3 - 1 , 0 ) + max ( 2 - 2 - 1 , 0 ) + ( 2 - 1 - 1 ) ) * 10 = 0$$

$$V = min ( 1 , abs ( 2 - 3 ) + abs ( 2 - 2 ) * 3 + abs ( 2 - 1 ) * 3 ) = 1 ( Valid )$$

$$V * ( max ( ( 2 - 3 ) , 0 ) + 1 ) * 1 + 3 * ( ( 2 - 2 ) + 1 ) + 3 * ( ( 2 - 1 ) + 1 ) = 10 ( high )$$

In another instance, when L1-asset may comprise 1×L2 and 1 internet connection: B=(4−0−1)*10 . . . =>high. In another instance, when the L2-asset may comprise 1×L1, 3×L2, and 2×L3 connections, B= . . . =0 (no 2 layer jumps), V*(max((2−3), 0)+1)*1+3*((2−2)+1)+2*((2−1)+1)=8(Medium).

In another instance, when L2-asset may comprise 2×L1, 2×L2, and 4×L3 connections,

$$B = ( max ( 2 - 4 - 1 , 0 ) + max ( 2 - 2 - 1 , 0 ) + ( 2 - 2 - 1 ) ) \times 10 = 0 ,$$

$$V = min ( 1 , \vert 2 - 4 \vert + \vert 2 - 2 \vert \times 2 + \vert 2 - 2 \vert \times 4 ) = 1 ( Valid ) ,$$

$$Criticality = V \times ( max ( 2 - 4 , 0 ) + 1 ) \times 1 + 2 \times ( ( 2 - 2 ) + 1 ) + 4 \times ( ( 2 - 2 ) + 1 ) = 10 ( High ) .$$

In another instance, when L3-asset may comprise 1×L1, 2×L2, and 2×L3 connections,

$$B = ( max ( 3 - 2 - 1 , 0 ) + max ( 3 - 1 - 1 , 0 ) + ( 3 - 2 - 1 ) ) \times 5 = 15 ,$$

$$V = min ( 1 , \vert 3 - 2 \vert + \vert 3 - 1 \vert \times 2 + \vert 3 - 2 \vert \times 2 ) = 1 ( Valid ) ,$$

$$Criticality = V \times ( max ( 3 - 2 , 0 ) + 1 ) \times 1 + 2 \times ( ( 3 - 1 ) + 1 ) + 2 \times ( ( 3 - 2 ) + 1 ) = 15 ( High ) .$$

In another instance, when L1-asset with 1×L2 and 2 internet connections, B=(4−0−1)×10=30(High). In another instance, when L2-asset with 2×L1, 2×L2, and 1×L3 connections, B=0, and Criticality=V×(max(2−2, 0)+1)×1+2×((2−2)+1)+1×((2−1)+1)=6(Medium).

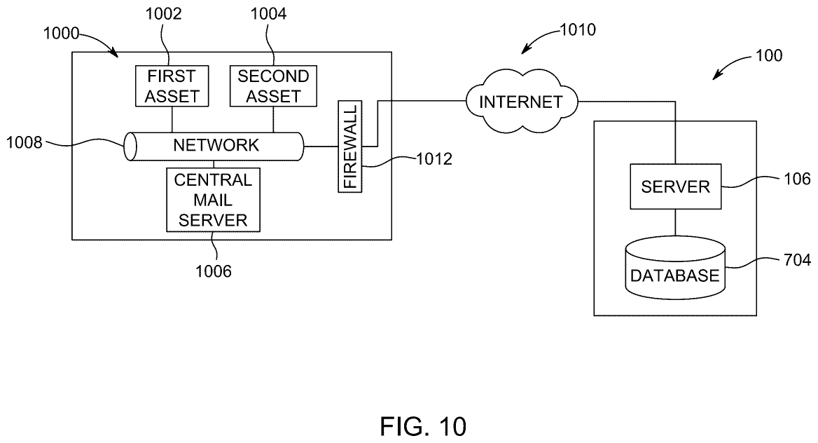

FIG. 10 illustrates a network diagram showing response of an industrial control network 1000 against a cyber-attack using the trained ML model 204, in accordance with an example embodiment of the present disclosure.

In some embodiments, the industrial control network 1000 may comprise one or more assets. Further, the one or more assets may comprise a first asset 1002 and a second asset 1004. In some embodiments, each of the one or more assets may be configured to perform corresponding operations within the industrial environment. In some embodiments, each of the one or more assets may be coupled with a central mail server 1006 of the industrial control network 102 through a network 1008. Further, the central mail server 1006 may facilitate controlling and monitoring internal operations of the one or more assets of the industrial control network 1000. Further, the central mail server 1006 may be connected with the server 106 of the system through the internet 1010. Further, the system 100 may comprise the database 704. Further, the database 704 may be deployed with the trained ML model 204.

In some embodiments, the server 106 of the system 100 may be configured to fetch the trained ML model 204 from the database 704. Further, the server 106 of the system 100 may be configured to deploy the trained ML model 204 into the central mail server 1006 of the industrial control network 1000. Further, the central mail server 1006 of the industrial control network 1000 may be configured to categorize the asset criticality for each of the one or more assets of the industrial control network 1000. In one example, the central mail server 1006 may categorize the first asset 1002 with the high criticality and the second asset 1004 with the low criticality. Further, the central mail server 1006 may be configured to categorize the asset criticality for each of the one or more assets using the trained ML model 204.

In one instance, when a cyber-attack targets the industrial control network 1000. Further, the cyber-attack may be intended to breach into the industrial control network 1000 through various means such as malware, phishing, or exploiting vulnerabilities in the industrial control network 1000. Further, the cyber-attack may be aimed to disrupt operations, steal sensitive data, or gain control over critical assets. Further, the central mail server 1006 may be configured to detect the cyber-attack through unusual activities or anomalies into the operations of the industrial control network 1000. Further, upon detecting the cyber-attack, the central mail server 1006 may activate a defense mechanism to protect the industrial control network 1000. Firstly, the central mail server 1006 may activate a firewall 1012 that may be integrated into the industrial control network 1000 and communicatively coupled with the central mail server 1006. Further, the firewall 1012 may be configured to barricade and prevent unauthorized access to filter out a malicious traffic of external networks. Further, the central mail server 1006 may coordinate with the firewall 1012 to enforce one or more security protocols into the network 1008 of the industrial control network 1000. Further, the one or more security protocols may comprise at least one of blocking suspicious IP addresses, shutting down vulnerable communication ports, and isolating affected segments of the network.

Secondly, the central mail server 1006 may be configured to monitor the asset criticality via the trained ML model 204. Further, the central mail server 1006 may be configured to ensure the assets the industrial control network 1000 that may be categorized with the high criticality may receive priority protection. In one example, if the first asset 1002, categorized with the high criticality is under the cyber-attack, the central mail server 1006 may ensure that all possible measures may be taken to secure the first asset 1002. Further, the possible measures may comprise at least one of rerouting data flows, enhancing encryption, and deploying additional security resources to safeguard the first asset 1002. In another example, if the second asset 1004, categorized with the high criticality is under the cyber-attack, the central mail server 1006 may ensure that all possible measures may be taken to secure the second asset 1004. Further, the possible measures may comprise at least one of rerouting data flows, enhancing encryption, and deploying additional security resources to safeguard the second asset 1004.

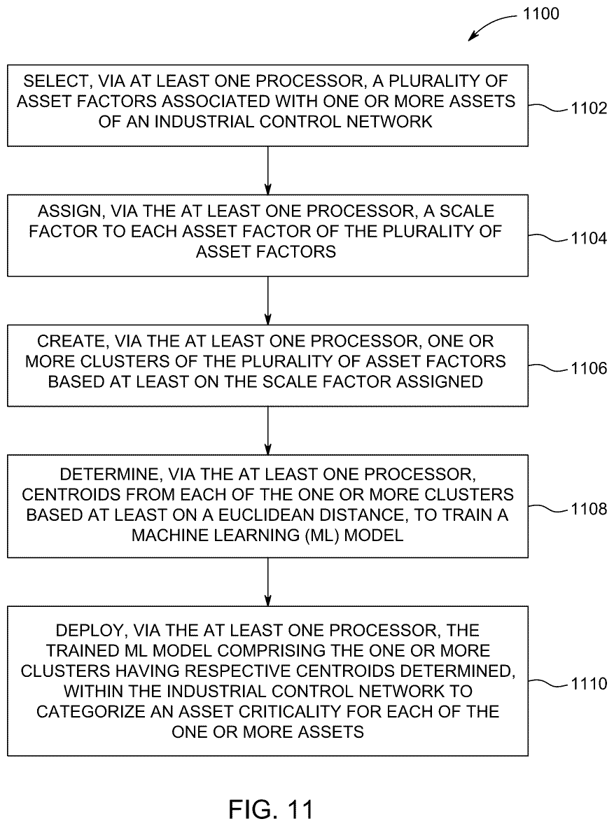

FIG. 11 illustrates a flowchart showing a method 1100 for auto-categorizing asset criticality using the ML technique in the industrial control network 102, in accordance with an example embodiment of the present disclosure. FIG. 11 is described in conjunction with FIGS. 1-10.

At operation 1102, the at least one processor 200 may be configured to select the plurality of asset factors associated with the one or more assets 300 of the industrial control network 102. Further, the plurality of asset factors may correspond to the specific criteria used to access characteristics, vulnerabilities, and criticality of each of the one or more assets 300 within the industrial control network 102. Further, the one or more assets 300 within the industrial control network 102 may comprise at least one of the programmable logic controllers (PLCs), remote terminal units (RTUs), supervisory control and data acquisition systems (SCADA), distributed control systems (DCS), one or more sensors, or actuators. Further, the plurality of asset factors may include but not limited to the active own operational technological (OT) ports, the direct connection to known OT endpoint, the indirect connection to the OT endpoints, use of OT protocols, the number of connections to information technology (IT) endpoints, or the connection to external subnets.

For example, in a large scale manufacturing plant an industrial control network 102 having a network of one or more assets 300 such as machines, sensors, and control systems is deployed at least one processor 200 associated with the system 100 is configured to select a plurality of asset factors associated with the one or more assets 300. The plurality of asset factors includes but not limited to an active own operational technological (OT) ports, a direct connection to known OT endpoint, an indirect connection to the OT endpoints “e.g. wireless connections between two or more assets”, use of OT protocols “e.g. fault tolerant Ethernet (FTE) heartbeat, Delta-V, redundant network routing protocol (RNRP), Vnet/IP”, a number of connections to information technology (IT) endpoints, or a connection to external subnets “e.g. internet”.

At operation 1104, the at least one processor 200 may be configured to assign the scale factor to each asset factor of the plurality of asset factors. Further, the scale factor may define the weightage assigned to each asset factor of the plurality of asset factors. In some embodiments, the scale factor may define importance of each asset factor of the plurality of asset factors. In one example, the scale factor may be assigned manually by a user. Further, the user device 108 associated with the system 100 may facilitate the user to assign the scale factor to each asset factor. In another example, the scale factor may be or assigned automatically using artificial intelligence (AI)/ML technique. The AI/ML technique may involve collecting and preprocessing relevant data, selecting appropriate models, training the models based on the plurality of asset factors of each of the one or more assets 300 of the industrial control network 102.

In one example, the at least one processor 200 is configured to assign a scale factor to each asset factor of the plurality of asset factors. Further, the scale factor for active own operational technological (OT) ports=500, a direct connection to known OT endpoint=300, an indirect connection to the OT endpoints=150, use of OT protocols=300, a number of connections to information technology (IT) endpoints=3 values (5, 10, 15), or a connection to external subnets=30.

In another example, the industrial control network 102 comprises one or more assets 300 having high criticality such as production line machinery. Further, the one or more assets 300 having the high criticality may be assigned with a scale factor of 5. Further, the industrial control network 102 comprises one or more assets 300 having medium criticality such as conveyor belts and robotic arms. Further, the one or more assets 300 having the medium criticality may be assigned with a scale factor of 3. Further, the industrial control network 102 comprises one or more assets 300 having low criticality such as lighting and HVAC systems. Further, the one or more assets having the low criticality may be assigned with a scale factor of 1.

At operation 1106, the at least one processor 200 may be configured to create the one or more clusters 500 of the plurality of asset factors based at least on the scale factor assigned. In some embodiments, the one or more clusters 500 of the plurality of asset factors may comprise the one or more groups of asset factors of the plurality of asset factors having similar impact or importance level as represented by corresponding scale factor assigned. For example, the asset factors from the plurality of asset factors having similar importance or influence on the industrial control network 102 may be organized into same cluster from the one or more clusters 500. The at least one processor 200 may be configured to create the one or more clusters 500 of the plurality of asset factors in accordance with the scale factor assigned. The one or more clusters 500 are defined by a “K-means”.

In one example, the at least one processor 200 is configured to create one or more clusters 500 of the plurality of asset factors. The one or more clusters 500 comprises cluster-1, cluster-2, and cluster-3. Further, the cluster-1 502 includes the one or more assets 300 with the high-criticality (scale factor 5), such as the main production line machinery. Further, the one or more assets 300 with the high-criticality are crucial for the plant's operation and any failure here may significantly impact production. Further, the cluster-2 504 includes the one or more assets 300 with the medium-criticality (scale factor 3), such as robotic arms and conveyor belts. Further, the cluster-3 506 includes the one or more assets 300 with the low-criticality (scale factor 1), such as sensors.

In another example, the one or more clusters 500 comprises cluster-1 502, cluster-2 504, cluster-3 506, cluster-4 508, and cluster-5 510. Further, the cluster-1 502 includes the one or more assets 300 with the high-criticality (scale factor 10), such as the main production line machinery. Further, the cluster-2 504 includes the one or more assets 300 with the high-criticality (scale factor 8). Further, the cluster-3 506 includes the one or more assets 300 with the medium-criticality (scale factor 7). Further, the cluster-4 508 includes the one or more assets 300 with the medium-criticality (scale factor 5). Further, the cluster-5 510 includes the one or more assets 300 with the low-criticality (scale factor 3).

At operation 1108, the at least one processor 200 may be configured to determine centroids from the one or more clusters 500 based at least on the Euclidean distance to train the ML model 204. Further, the centroids may be configured to uniquely define each of the one or more clusters 500. Further, the Euclidean distance may correspond to the total numeral difference of coordinates of the plurality of asset factors.

Further, the at least one processor 200 is configured to identify a centroid, based at least on the total numerical difference. Further, the centroid may correspond to a central point that represents an average performance metrics of the one or more assets 300 within the one or more clusters 500. Further, the at least one processor 200 is configured to train the ML model 204 based at least on the determined centroids. In one instance, when a new conveyor belt is added to the industrial control network 102, the trained ML model 204 quickly classifies the new conveyor belt into the one or more clusters 500 by comparing its metrics to the existing centroid.

At operation 1110, the at least one processor 200 may be configured to deploy the trained ML model 204 comprising the one or more clusters 500 having respective centroids determined, within the industrial control network 102 to categorize the asset criticality for each of the one or more assets 300. Further, the asset criticality categorized for each of the one or more assets 300 may correspond to at least one of the high criticality, the medium criticality, or the low criticality. Further, by incorporating the trained ML model 204, the system 100 may enhance its ability to predict and classify the plurality of asset factors.

For example, the at least one processor 200 is configured to deploy the trained ML model 204 within the industrial control network 102. Further, the trained ML model 204 comprises the one or more clusters 500 of the one or more assets 300, with centroids determined based on the plurality of asset factors. Further, the trained ML model 204 may cause the at least one processor 200 to categorize the asset criticality of the one or more assets 300. Further, the at least one processor 200 categorizes the one or more assets 300 such as assembly line machines with high criticality. Since, the assembly line machines are crucial for continuous production. Further, the at least one processor 200 categorizes the one or more assets 300 such as robotic arms with medium criticality. Further, the at least one processor 200 categorizes the one or more assets 300 such as packing or labelling machines with low criticality.

In some embodiments, a non-transitory machine-readable information storage medium is disclosed. The non-transitory machine-readable information storage medium may comprise one or more instructions which when executed by at least one processor 200 cause the at least one processor 200 to select a plurality of asset factors associated with one or more assets 300 of an industrial control network 102. The plurality of asset factors correspond to a specific criteria used to access characteristics, vulnerabilities, and criticality of each of the one or more assets 300 within the industrial control network 102. The plurality of asset factors comprise at least one of an active own operational technological (OT) ports, a direct connection to known OT endpoint, an indirect connection to the OT endpoints, use of OT protocols, a number of connections to information technology (IT) endpoints, or a connection to external subnets. The one or more assets 300 within the industrial control network 102 comprises at least one of programmable logic controllers (PLCs), remote terminal units (RTUs), supervisory control and data acquisition systems (SCADA), distributed control systems (DCS), one or more sensors, or actuators. Further, the non-transitory machine-readable information storage medium may comprise one or more instructions which when executed by the at least one processor 200 cause the at least one processor 200 to assign a scale factor to each asset factor of the plurality of asset factors. The scale factor defines a weightage assigned to each asset factor of the plurality of asset factors. The scale factor is either assigned manually by a user or assigned automatically using artificial intelligence (AI)/ML technique.

Further, the non-transitory machine-readable information storage medium may comprise one or more instructions which when executed by the at least one processor 200 cause the at least one processor 200 to create one or more clusters 500 of the plurality of asset factors based at least on the scale factor assigned. The scale factor for each asset factor is configured to allow a spatial distance between the one or more clusters 500 and eliminate errors induced by intersections of the one or more clusters 500. Further, the non-transitory machine-readable information storage medium may comprise one or more instructions which when executed by the at least one processor 200 cause the at least one processor 200 to determine centroids from each of the one or more clusters 500 based at least on a Euclidean distance, to train a machine learning (ML) model 204. The centroids are configured to uniquely define each of the one or more clusters 500, and wherein the Euclidean distance corresponds to a total numerical difference of coordinates of the plurality of asset factors.

Further, the non-transitory machine-readable information storage medium may comprise one or more instructions which when executed by the at least one processor 200 cause the at least one processor 200 to deploy the trained ML model 204 comprising the one or more clusters 500 having respective centroids determined, within the industrial control network 102 to categorize an asset criticality for each of the one or more assets 300. The asset criticality categorized for each of the one or more assets 300 corresponds to at least one of high criticality, medium criticality, or low criticality. Further, the non-transitory machine-readable information storage medium may comprise one or more instructions which when executed by the at least one processor 200 cause the at least one processor 200 to determine the asset criticality based at least on a criticality score associated with each of the one or more assets 300.

The present disclosure streamlines the process of categorizing the asset criticality of the one or more assets 300 of the industrial control network 102. Embodiments of the present invention may ensure a precise analysis of the asset criticality based on the determined centroids of the one or more clusters 500. Embodiments of the present invention may improve allocation of resources and preventing measures for the one or more assets 300 with a high criticality. Embodiments of the present invention may group the one or more assets 300 having similar importance or impact on the industrial control network 102.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
selecting, via at least one processor, a plurality of asset factors associated with one or more assets of an industrial control network, wherein the plurality of asset factors corresponds to a specific criteria used to access characteristics, vulnerabilities, and criticality of each of the one or more assets within the industrial control network;
assigning, via the at least one processor, a scale factor to each asset factor of the plurality of asset factors, wherein the scale factor defines a weightage assigned to each asset factor of the plurality of asset factors;
creating, via the at least one processor, one or more clusters of the plurality of asset factors based at least on the scale factor assigned;
determining, via the at least one processor, centroids from each of the one or more clusters based at least on a Euclidean distance, to train a machine learning (ML) model, wherein the centroids are configured to uniquely define each of the one or more clusters, and wherein the Euclidean distance corresponds to a total numerical difference of coordinates of the plurality of asset factors; and
deploying, via the at least one processor, the trained ML model comprising the one or more clusters having respective centroids determined, within the industrial control network to categorize an asset criticality for each of the one or more assets.

2. The method of claim 1, wherein the plurality of asset factors comprise at least one of an active own operational technological (OT) ports, a direct connection to known OT endpoint, an indirect connection to the OT endpoints, use of OT protocols, a number of connections to information technology (IT) endpoints, or a connection to external subnets.

3. The method of claim 1, wherein the one or more assets within the industrial control network comprises at least one of programmable logic controllers (PLCs), remote terminal units (RTUs), supervisory control and data acquisition systems (SCADA), distributed control systems (DCS), one or more sensors, or actuators.

4. The method of claim 1, wherein the asset criticality categorized for each of the one or more assets corresponds to at least one of high criticality, medium criticality, or low criticality.

5. The method of claim 1 further comprising determining, via the at least one processor, the asset criticality based at least on a criticality score associated with each of the one or more assets.

6. The method of claim 1, wherein the scale factor for each asset factor is configured to allow a spatial distance between the one or more clusters and eliminate errors induced by intersections of the one or more clusters.

7. The method of claim 1, wherein the scale factor is either assigned manually by a user or assigned automatically using artificial intelligence (AI)/ML technique.

8. A system comprising:
a memory; and
at least one processor communicatively coupled to the memory, wherein the at least one processor is configured to:
select a plurality of asset factors associated with one or more assets of an industrial control network, wherein the plurality of asset factors correspond to a specific criteria used to access characteristics, vulnerabilities, and criticality of each of the one or more assets within the industrial control network;
assign a scale factor to each asset factor of the plurality of asset factors, wherein the scale factor defines a weightage assigned to each asset factor of the plurality of asset factors;
create one or more clusters of the plurality of asset factors based at least on the scale factor assigned;
determine centroids from each of the one or more clusters based at least on a Euclidean distance, to train a machine learning (ML) model, wherein the centroids are configured to uniquely define each of the one or more clusters, and wherein the Euclidean distance corresponds to a total numerical difference of coordinates of the plurality of asset factors; and
deploy the trained ML model comprising the one or more clusters having respective centroids determined, within the industrial control network to categorize an asset criticality for each of the one or more assets.

9. The system of claim 8, wherein the plurality of asset factors comprise at least one of an active own operational technological (OT) ports, a direct connection to known OT endpoint, an indirect connection to the OT endpoints, use of OT protocols, a number of connections to information technology (IT) endpoints, or a connection to external subnets.

10. The system of claim 8, wherein the one or more assets within the industrial control network comprises at least one of programmable logic controllers (PLCs), remote terminal units (RTUs), supervisory control and data acquisition systems (SCADA), distributed control systems (DCS), one or more sensors, or actuators.

11. The system of claim 8, wherein the asset criticality categorized for each of the one or more assets corresponds to at least one of high criticality, medium criticality, or low criticality.

12. The system of claim 8, wherein the at least one processor is configured to determine the asset criticality based at least on a criticality score associated with each of the one or more assets.

13. The system of claim 8, wherein the scale factor for each asset factor is configured to allow a spatial distance between the one or more clusters and eliminate errors induced by intersections of the one or more clusters.

14. The system of claim 8, wherein the scale factor is either assigned manually by a user or assigned automatically using artificial intelligence (AI)/ML technique.

15. A non-transitory machine-readable information storage medium comprising one or more instructions which when executed by at least one processor cause the at least one processor to:
select a plurality of asset factors associated with one or more assets of an industrial control network, wherein the plurality of asset factors correspond to a specific criteria used to access characteristics, vulnerabilities, and criticality of each of the one or more assets within the industrial control network;
assign a scale factor to each asset factor of the plurality of asset factors, wherein the scale factor defines a weightage assigned to each asset factor of the plurality of asset factors;
create one or more clusters of the plurality of asset factors based at least on the scale factor assigned;
determine centroids from each of the one or more clusters based at least on a Euclidean distance, to train a machine learning (ML) model, wherein the centroids are configured to uniquely define each of the one or more clusters, and wherein the Euclidean distance corresponds to a total numerical difference of coordinates of the plurality of asset factors; and
deploy the trained ML model comprising the one or more clusters having respective centroids determined, within the industrial control network to categorize an asset criticality for each of the one or more assets.

16. The non-transitory machine-readable information storage medium of claim 15, wherein the plurality of asset factors comprise at least one of an active own operational technological (OT) ports, a direct connection to known OT endpoint, an indirect connection to the OT endpoints, use of OT protocols, a number of connections to information technology (IT) endpoints, or a connection to external subnets.

17. The non-transitory machine-readable information storage medium of claim 15, wherein the one or more assets within the industrial control network comprises at least one of programmable logic controllers (PLCs), remote terminal units (RTUs), supervisory control and data acquisition systems (SCADA), distributed control systems (DCS), one or more sensors, or actuators.

18. The non-transitory machine-readable information storage medium of claim 15, wherein the asset criticality categorized for each of the one or more assets corresponds to at least one of high criticality, medium criticality, or low criticality.

19. The non-transitory machine-readable information storage medium of claim 15, wherein the at least one processor is configured to determine the asset criticality based at least on a criticality score associated with each of the one or more assets.

20. The non-transitory machine-readable information storage medium of claim 15, wherein the scale factor for each asset factor is configured to allow a spatial distance between the one or more clusters and eliminate errors induced by intersections of the one or more clusters, and wherein the scale factor is either assigned manually by a user or assigned automatically using artificial intelligence (AI)/ML technique.
